(19) United States
(12) Patent Application Publication
(10) Pub. No.: US 2007/0241890 A1
(43) Pub. Date: Oct. 18, 2007

(54) Torque measurement system

(76) Inventor: Jun Yoshioka, Canton, MI (US)

Correspondence Address: BERENATO, WHITE & STAVISH, 6550 ROCK SPRING DRIVE, SUITE 240, BETHESDA, MD, 20817, US

(21) Appl. No.: 11/393,946

(22) Filed: Mar. 31, 2006

(51) Int. Cl. G08B 1/08; G08B 21/00; G08B 13/14

(52) U.S. Cl. 340/539.22; 340/665; 340/572.1

(57) ABSTRACT

The present invention is directed to an Apparatus for measuring torque in a shaft or driveline component of a vehicle. A radio frequency (RF) tag is connected to the shaft to facilitate communication to an RF reader and is capable of storing at least one sensed physical characteristic such as torque. A torque sensor is operatively connected to the shaft in communication with the RF tag. The RF reader includes a transmitter provided to send modulated radio frequency transmissions to both supply power to the RF tag and associated sensor and trigger a responsive transmission signal indicative of sensed torque. The frequency tag reader is positioned adjacent to the shaft and operable to read the signal transmitted by the RF tag. The RF tag may be continuously triggered and read by the RF modulator/reader in rapid cycles to facilitate continuous monitoring of object to be sensed.

### BACKGROUND OF THE INVENTION

1. Field of the Invention

The present invention is directed to torque sensing systems and more particularly to a torque sensing system using a Radio Frequency (RF) tag.

2. Description of the Related Art

RF tag technology is well known in the art. Small lightweight RF foil tags have long been implemented in security systems in retail stores. A foil RF tag is secured to a product capable of storing information regarding the product or sale status. A RF modulator is used to read the tag, record the sale of the item, and write to the tag to change the status to purchased, to allow the product and tag to leave the store without tripping the stores security alert system. The technology to use such RF tags for inventory and assembly lines etc. are known in the art to facilitate reading and writing to small RF foil tags without contact and without the need for a power supply to the tag itself. Rather, the tag relies on modulated radio frequencies from the RF reader/writer to exchange information. Various RF systems are disclosed in U.S. Pat. Nos. 6,717,507; 6,806,808; 5,055,659; 5,030,807; 6,107,910; 6,580,358; & 6,778,847 each of which are hereby incorporated herein by reference.

Heretofore in the art of torque sensing, more complicated, expensive & cumbersome means have been employed to passively monitor torque in a shaft such as expensive telemetry systems and those disclose in U.S. Pat. Nos. 5,585,571; and 6,532,833 each of which are herein incorporated by reference. Other use of modulated Radio frequency to passively sense an external condition, such as tire pressure, are disclosed in U.S. Pat. Nos. 6,710,708; 6,417,766; 6,914,529; & 5,764,138 each of which are hereby incorporated herein by reference.

### SUMMARY OF THE INVENTION

The present invention is directed to an apparatus for measuring at least one physical characteristic, torque for example, of a shaft or driveline component of a vehicle. A radio frequency (RF) tag is associated with the shaft to facilitate communication to an RF reader. The RF tag is capable of storing a physical characteristic of the driveline component such as torque. A sensor to measure a physical characteristic of the driveline component, torque, is operatively connected thereto in communication with the RF tag. The RF reader includes a transmitter provided to send modulated radio frequency transmissions that both supply power to the RF tag and associated sensor and trigger a responsive transmission signal indicative of sensed torque. The frequency tag reader is positioned adjacent to the driveline component and operable to read the signal transmitted by the RF tag. The RF tag may be continuously triggered and read by the RF modulator/reader in rapid cycles to facilitate continuous monitoring of object to be sensed.

### BRIEF DESCRIPTION OF THE DRAWINGS

FIG. 1 is a plan view of a shaft with attached RF tag torque sensor and associated reader according to the present invention.

FIG. 2 is a schematic drawing showing the RF tag and associated resonator proximate an associated RF modulator/reader.

### DESCRIPTION OF THE PREFERRED EMBODIMENT

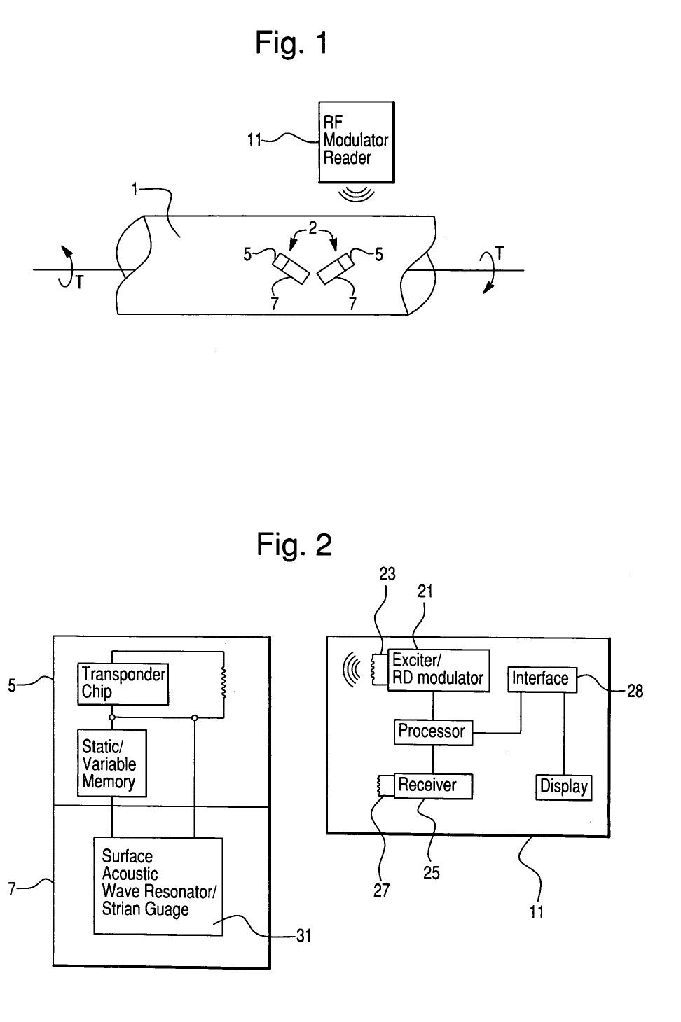

The present invention is directed to passively sensing torque in a shaft or other driveline shaft of a vehicle. An RF tag 2 is employed to passively and non-invasively measure torque in a shaft 1, or driveline component of a vehicle without the need of any direct contact between the tag and reader. More significantly there is no need for expensive and complicated telemetry systems to sense torque in the shaft. The RF tag 5 stores and communicates data associated with the shaft to an RF modulator/reader 11. FIG. 1 depicts a shaft with an RF tag 5 and associated integrated strain gauge/torque sensor 7 attached thereto. The RF tag 5 comprises at least one RF transponder chip that stores and communicates both static and variable data relating to the shaft 1 such as data regarding the strain, torque or other conditions. The static Data may simply be data regarding the particular shaft, size material, and associated vehicle data to facilitate identification of the shaft and its associated application, such as a particular driveline component of a particular vehicle. The variable data contains data regarding the current state of the shaft such as torque and or strain amongst other conditions. The present invention seeks to employ a simple inexpensive means to rapidly and non-invasively sense torque in a driveline shaft component of a vehicle which can be implemented during use of the vehicle or by simple inspection by proximate application of a reader. One known RF tags and associated reader that maybe employed to store the static and variable data and facilitate communication to a reader is that disclosed in U.S. Pat. No. 5,764,138 may be employed. Such RF tags may be simply altered to be connected to and power a strain sensor.

In order to measure torque, or strain indicate of torque, a strain gauge is connected to the RF tag to communicate/store information regarding sensed strain (indicate of torque) in the shaft 1. A surface acoustic wave resonator 31 may be employed to measure strain in the shaft 1. Such strain sensors are known in the art. Interleaved electrodes of conductive material are deposited on a flexible piezoelectric substrate which may be directly adhered to the shaft 1. Such resonators require very little power and produce an output signal with varied frequencies dependent on strain (indicative of torque) in the shaft. Use of two or more resonators may be employed for more accurate and measurement of other conditions of the shaft as may be recognized in the art. The resonator 7/31 is simply coupled to the RF tag 5 and draws little power from the RF tag 5 when activated by the RF modulator 11. Both the RF tags 5 and strain/torque sensors 7 are small and of extreme light weight which do not adversely affect the rotational inertia of the shaft 1. The combination of an RF tag and surface acoustic wave resonator facilitates applications in rapidly rotating shafts such as during use in a vehicle. Such an arrangement lends itself to sensing peak strain/torque and other data during field use. Such information may, for example, be useful to increase product safety and otherwise enhance maintenance amongst other valuable applications.

FIG. 2 depicts a schematic of the integrated 2 RF tags 5 and torque sensor 7 proximate the reader 11. The reader/RF modulator 11 includes an exciter 21 coupled to an RF excitation coil 23 and a receiver 25 coupled to an RF receiver coil 27. The RF reader/modulator 11 queries the RF tags 2 by using a modulated RF signal generated by the exciter 23. The RF tag 5 responds to the RF query signal by supplying power to the resonator 31 and storing the variable date indicative of the frequency of the signal output of the resonator 31. The RF tag 5 then transmits both the static associated with the shaft 1 and the stored variable data indicative of strain/torque back to the reader 11.

The reader 11 includes a display and interface controlled by a central processor. In one application, the reader 11 is simply mounted to the vehicle proximate the shaft and associated RF tag and in coupled to the engines computer control system. In such an embodiment, the shafts torque can be continuously monitored and stored and mapped in conjunction with driving conditions. In such this embodiment, the engine control system simply sends a triggering signal to the reader interface to trigger the exciter to modulate the RF signal and activate the RF tag and torque sensor. In yet additional embodiments, the torque reader may be portable and include a user display to read sensed torque. Such an embodiment facilitates measuring torque in either isolated or controlled conditions as part of quality control, inspection, safety inspection or maintenance programs. In ether embodiment, the use of foil RF tags to sense torque in a shaft or other driveline component of a vehicle eliminates the need for costly telemetry systems or other expensive and complicated measures.

While the foregoing invention has been shown and described with reference to a preferred embodiment, it will be understood by those possessing skill in the art that various changes and modifications may be made without departing from the spirit and scope of the invention.

What is claimed is:

1. An apparatus for measuring torque in an object, said apparatus comprising:
a torque sensor connected to said object provided to sense torque in said object;
a radio frequency tag connected to said objected and in communication with said torque sensor, said radio frequency tag provided to both store and transmit a signal indicative of said sensed torque;
a radio frequency tag reader positioned adjacent to said object and operable to read the signal transmitted by said radio frequency tag, said radio frequency tag reader comprising a transmitter provided to send modulated radio frequency transmissions to said RF tag to both supply power to both said radio frequency tag and associated sensor and prompt a responsive signal indicative of said sensed torque, and a receiver for receiving and storing said sensed torque.

2. The apparatus according to claim 1, wherein said object is comprised of a shaft.

3. The apparatus according to claim 2, wherein said shaft is a driveline component of a vehicle.

4. The apparatus according to claim 1, wherein
Said radio frequency tag includes a transponder and memory chip in communication with said torque measuring device.

5. The apparatus according to claim 4, wherein said torque sensor is comprised of a surface acoustic wave resonator.

6. According to claim 5; wherein said torque sensor and said radio frequency tag are integrated into a single integrated device;
said reader includes an RF excitation coil coupled to an exciter RF modulator to facilitate excitation of said integrated device, and an RF receiver coil coupled to a receiver to facilitate reception of signals transmitted from said transponder chip, and a processing device selectively controlling said exciter RF modulator and processing said signals transmitted from said transponder chip to information indicative of sensed torque in said object, and a display to display said information.

7. The apparatus according to claim 3, wherein said torque sensor and said radio frequency device are integrated into a single chip device on a single chip, said apparatus includes at least two said singe chip devices disposed in different orientations relative to said driveline component.
